(19) United States
(12) Patent Application Publication
(10) Pub. No.: US 2016/0087292 A1
(43) Pub. Date: Mar. 24, 2016

(54) FUEL CELL SYSTEM

(71) Applicant: TOYOTA JIDOSHA KABUSHIKI KAISHA, Toyota-shi (JP)

(72) Inventors: Go TEJIMA, Toyota-shi (JP); Masaya YANO, Okazaki-shi (JP)

(73) Assignee: TOYOTA JIDOSHA KABUSHIKI KAISHA, Toyota-shi (JP)

(21) Appl. No.: 14/857,938

(22) Filed: Sep. 18, 2015

(30) Foreign Application Priority Data
Sep. 22, 2014 (JP) 2014-193080
Nov. 12, 2014 (JP) 2014-229846

(51) Int. Cl. H01M 8/04

(52) U.S. Cl. CPC H01M 8/04291; H01M 2220/20

(57) ABSTRACT

A fuel cell system includes a fuel cell provided in a vehicle; and an electronic control unit configured to determine whether an amount of water in the fuel cell is equal to or smaller than a predetermined amount, and to prevent dryness of the fuel cell by increasing the amount of water in the fuel cell when a speed of the vehicle is equal to or higher than a predetermined threshold value in a case where the electronic control unit determines that the amount of water in the fuel cell is equal to or smaller than the predetermined amount.

### INCORPORATION BY REFERENCE

The disclosure of Japanese Patent Application No. 2014-229846 filed on Nov. 12, 2014 including the specification, drawings and abstract is incorporated herein by reference in its entirety.

### BACKGROUND OF THE INVENTION

1. Field of the Invention

The invention relates to a fuel cell system.

2. Description of Related Art

A fuel cell that receives supply of reaction gas (fuel gas and oxidizing gas) and generates electric power has been put into practical use. In the fuel cell, the fuel is oxidized by an electrochemical process, and thus, energy emitted due to the oxidation reaction is directly converted to electric energy. The fuel cell includes a membrane-electrode assembly in which paired electrodes (an anode electrode and a cathode electrode) are disposed on respective side surfaces of a polymer electrolyte membrane through which hydrogen ions are selectively transported. Each of the electrodes is formed of a porous material. Each of the electrodes includes a catalyst layer that promotes the electrochemical reaction. The catalyst layer includes catalyst-supporting carbon that is carbon supporting a metal catalyst such as platinum, and an ionomer (a polymer electrolyte) that conveys protons and oxygen.

It is known that power generation performance of the fuel cell with the above-mentioned configuration decreases when the fuel cell is dried, for the following reason. The concentration of hydrogen peroxide increases due to the dryness of the fuel cell, and thus, OH radicals are generated. Accordingly, the ionomer included in the catalyst layer in each of the electrodes and fluorine components in the electrolyte membrane are decomposed. Thus, the proton conductivity of the ionomer decreases, and the solubility of oxygen in the ionomer decreases, and as a result, overvoltage decreases. Therefore, recently, technologies for preventing dryness of the fuel cell have been proposed (for example, refer to Japanese Patent Application Publication No. 2008-262824 (JP 2008-262824 A)). In a fuel cell system described in JP 2008-262824 A, in a low load range where a fuel cell is likely to be dried, a hydrogen pump is operated to circulate anode gas, thereby preventing dryness of an anode electrode.

In the fuel cell system described in JP 2008-262824 A, in the low load range, the hydrogen pump is operated to prevent dryness of the fuel cell, as described above. However, in a case where such a fuel cell system is provided in, for example, a vehicle, the operating noise of the hydrogen pump becomes larger than external sound or noise generated when the vehicle travels at a low speed (for example, noise of tires of the vehicle and/or the sound of wind). Accordingly, an occupant of the vehicle may feel uncomfortable.

### SUMMARY OF THE INVENTION

The invention provides a fuel cell system in which a dryness prevention operation is performed at appropriate timing without making an occupant feel uncomfortable.

A first aspect of the invention relates to a fuel cell system including a fuel cell provided in a vehicle; and an electronic control unit configured to determine whether an amount of water in the fuel cell is equal to or smaller than a predetermined amount, and to prevent dryness of the fuel cell by increasing the amount of water in the fuel cell when a speed of the vehicle is equal to or higher than a predetermined threshold value in a case where the electronic control unit determines that the amount of water in the fuel cell is equal to or smaller than the predetermined amount.

With the above-mentioned configuration, the dryness of the fuel cell can be prevented only when (i) the amount of water in the fuel cell is equal to or smaller than the predetermined amount (the fuel cell is in the dried state) and (ii) the speed of the vehicle in which the fuel cell is provided is equal to or higher than the predetermined threshold value (i.e., only when both of the conditions (i) and (ii) are satisfied). Accordingly, the operating noise of a device (for example, an auxiliary) used to prevent dryness of the fuel cell can be drowned out by sound caused by traveling of the vehicle (for example, sound of wind). Therefore, it is possible to prevent dryness of the fuel cell without making an occupant feel uncomfortable.

In the fuel cell system according to the first aspect, the electronic control unit may be configured to set a reference value to an average of impedances measured in a state in which the amount of water in the fuel cell is larger than the predetermined amount, and to determine that the amount of water in the fuel cell is equal to or smaller than the predetermined amount when a difference between the reference value and a currently measured impedance is equal to or larger than a predetermined threshold value.

With the above-mentioned configuration, the reference value is set to the average of the impedances measured in the state in which the amount of water in the fuel cell is larger than the predetermined amount (for example, a predetermined non-dried power generation state (i.e., a state in which electric power is generated under a predetermined condition under which the fuel cell is not dried) during an immediately preceding trip or during a current trip). The dryness determination can be performed (i.e., it is possible to determine whether the fuel cell is in the dried state), by comparing the reference value and the currently measured impedance. That is, the impedance in the predetermined non-dried power generation state is employed as the reference value, and the dryness determination can be performed using the reference value. Therefore, even when the reference value is changed due to aged deterioration of the fuel cell, the dryness determination can be accurately performed (i.e., it is possible to accurately determine whether the fuel cell is in the dried state).

A second aspect of the invention relates to a fuel cell system including a fuel cell provided in a vehicle; and an electronic control unit configured to determine whether an operating state of the fuel cell is a dryness-inducing operating state in which an amount of water in the fuel cell is decreased and dryness of the fuel cell is to be induced, and to perform a dryness prevention operation for preventing the dryness of the fuel cell by increasing the amount of water in the fuel cell when a speed of the vehicle is equal to or higher than a predetermined threshold value in a case where the electronic control unit determines that the operating state of the fuel cell is the dryness-inducing operating state.

With the above-mentioned configuration, the dryness prevention operation can be performed only when (i) the operating state of the fuel cell is the dryness-inducing operating state (i.e., the operating state in which the amount of water in the fuel cell is decreased and the dryness of the fuel cell is to be induced) and (ii) the speed of the vehicle in which the fuel cell is provided is equal to or higher than the predetermined threshold value (i.e., only when both of the conditions (i) (ii) are satisfied). Accordingly, the operating noise of a device (for example, an auxiliary) used to perform the dryness prevention operation can be drowned out by sound caused by the traveling of the vehicle (for example, sound of wind). Therefore, it is possible to perform the dryness prevention operation without making an occupant feel uncomfortable. Further, instead of directly determining whether the fuel cell is in the dried state, the operating state of the fuel cell is determined, and when the operating state is the dryness-inducing operating state, the dryness prevention operation is performed. Therefore, it is possible to prevent the dryness of the fuel cell from occurring in advance.

In the fuel cell system according to the second aspect, the electronic control unit may be configured to determine that the operating state of the fuel cell is the dryness-inducing operating state when a current generated by the fuel cell is equal to or smaller than a predetermined threshold value and the generated current continues to flow for a predetermined time period or longer.

With the above-mentioned configuration, when (i) the current generated by the fuel cell is in the low load range (that is, the generated current is equal to or smaller than the predetermined threshold value) and (ii) the generated current continues to flow for the predetermined time period or longer, it can be determined that the operating state of the fuel cell is the dryness-inducing operating state. That is, it is possible to determine the probability (possibility) of occurrence of dryness, instead of directly determining whether the fuel cell is in the dried state based on, for example, the measured impedance. Accordingly, even in the low load range where the change in the impedance is small, it is possible to prevent the dryness from occurring in advance.

In the fuel cell system according to the second aspect, the electronic control unit may be configured to determine that the operating state of the fuel cell is the dryness-inducing operating state when a rate of decrease in a load of the fuel cell or a rate of decrease in an output of the fuel cell is larger than a predetermined threshold value.

In a case where the load of the fuel cell (required electric power) sharply decreases from a high load to a low load, a large amount of the reaction gas (particularly, air as the oxidizing gas) is supplied to the fuel cell when the load is high, and there is a surplus of the reaction gas when the load becomes low. Thus, it is estimated that the fuel cell will be brought to the dried state due to the surplus reaction gas. Therefore, the rate of decrease in the load of the fuel cell (a decrease amount of the load of the fuel cell per unit time) or the rate of decrease in the output of the fuel cell (a decrease amount of the output of the fuel cell per unit time) is calculated, and when the calculated rate of decrease in the load (output) is larger than the predetermined threshold value, it can be determined that the operating state of the fuel cell is the dryness-inducing operating state.

In the fuel cell system according to the second aspect, the electronic control unit may be configured to determine that the operating state of the fuel cell is the dryness-inducing operating state when a temperature of the fuel cell is equal to or higher than a predetermined threshold value.

With the above-mentioned configuration, when the temperature of the fuel cell is relatively high (the temperature is equal to or higher than the predetermined threshold value), it can be determined that the operating state of the fuel cell is the dryness-inducing operating state. That is, it is possible to determine the probability (possibility) of occurrence of dryness based on the temperature of the fuel cell, instead of directly determining whether the fuel cell is in the dried state based on, for example, the measured impedance. Accordingly, even in the low load range where the change in the impedance is small, it is possible to prevent the dryness from occurring in advance.

The fuel cell system according to the first aspect may further include a fuel gas passage through which fuel gas is supplied to the fuel cell; a circulation passage through which fuel off-gas discharged from the fuel cell is returned to the fuel gas passage; and a circulation pump that delivers under pressure the fuel off-gas in the circulation passage, to the fuel gas passage. In this case, the electronic control unit may be configured to make an operation amount of the circulation pump larger than a normal operation amount when the speed of the vehicle is equal to or higher than the predetermined threshold value in the case where the electronic control unit determines that the amount of water in the fuel cell is equal to or smaller than the predetermined amount.

The fuel cell system according to the second aspect may further include a fuel gas passage through which fuel gas is supplied to the fuel cell; a circulation passage through which fuel off-gas discharged from the fuel cell is returned to the fuel gas passage; and a circulation pump that delivers under pressure the fuel off-gas in the circulation passage, to the fuel gas passage. In this case, the electronic control unit may be configured to make an operation amount of the circulation pump larger than a normal operation amount when the speed of the vehicle is equal to or higher than the predetermined threshold value in the case where the electronic control unit determines that the operating state of the fuel cell is the dryness-inducing operating state.

With the above-mentioned configuration, when (i) the fuel cell is in the dried state (or the operating state of the fuel cell is the dryness-inducing operating state) and (ii) the speed of the moving body in which the fuel cell is provided is equal to or higher than the predetermined threshold value (i.e., when both of the conditions (i) (ii) are satisfied), the amount of water contained in the fuel gas supplied to the fuel cell can be increased by making the operation amount of the circulation pump larger than the normal operation amount so as to increase the amount of the fuel off-gas delivered under pressure to the fuel gas passage. That is, the operation of increasing the operation amount of the circulation pump can be employed as the “dryness prevention operation”. Since the electric power consumed by the circulation pump is much smaller than the electric power consumed by the air compressor, it is possible to prevent the dryness of the fuel cell while saving the fuel. When the operation amount of the circulation pump is increased, the operating noise of the circulation pump can be drowned out by sound caused the movement of the moving body.

According to the above-mentioned first and second aspects of the invention, it is possible to provide the fuel cell system in which the dryness prevention operation can be performed at appropriate timing without making the occupant feel uncomfortable.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory diagram schematically showing a configuration of a fuel cell system according to a first embodiment of the invention;

FIG. 2 is a flowchart explaining an operation method for the fuel cell system according to the first embodiment of the invention;

FIG. 3 is a flowchart explaining a dryness determination process in the operation method shown in FIG. 2;

FIG. 4 is a flowchart explaining an operation method for a fuel cell system according to a second embodiment of the invention;

FIG. 5 is a flowchart explaining an operation determination process in the operation method shown in FIG. 4; and

FIG. 6 is a time chart showing a time history of an instructed value and a measured value of reaction gas supplied to the fuel cell.

### DETAILED DESCRIPTION OF EMBODIMENTS

Hereinafter, embodiments of the invention will be described with reference to the drawings. The descriptions regarding positional relations in a top-down direction, a right-left direction, and the like are based on the positional relations shown in the drawings, unless otherwise specified. The dimensional ratios are not limited to the dimensional ratios shown in the drawings. Further, each of the embodiments described below is an example embodiment for describing the invention, and accordingly, the invention is not limited to the embodiments. Further, various modifications may be made to the embodiments, without departing from the scope of the invention.

### First Embodiment

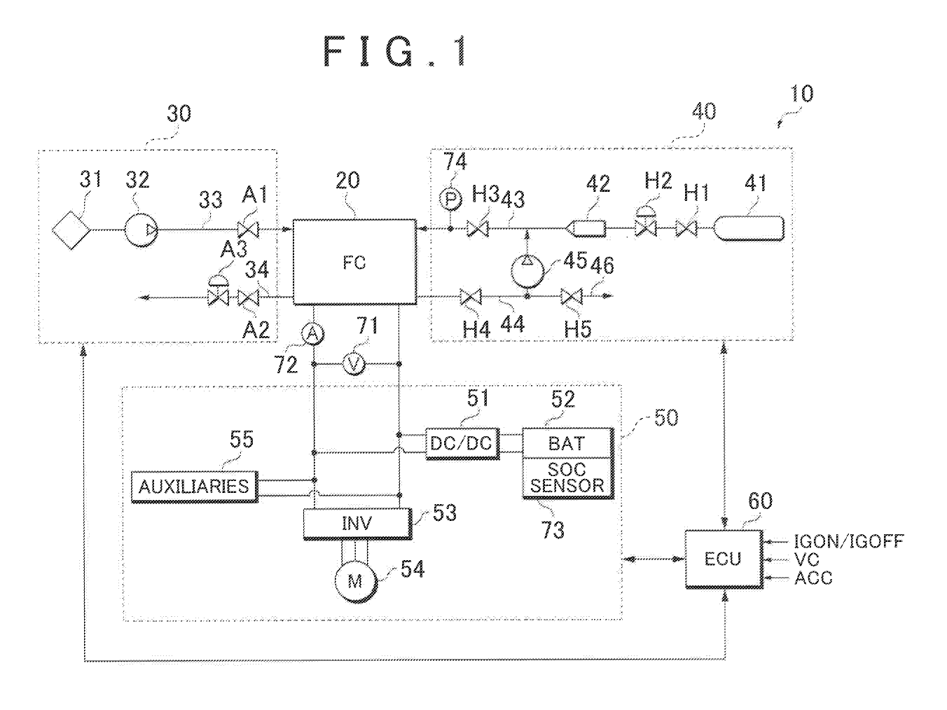

First, a fuel cell system 10 and an operation method for the fuel cell system 10 according to a first embodiment of the invention will be described with reference to FIG. 1 to FIG. 3.

A configuration of the fuel cell system 10 according to the embodiment will be described with reference to FIG. 1. The fuel cell system 10 functions as an in-vehicle power supply system provided, for example, in a fuel cell vehicle as a moving body. The fuel cell system 10 includes a fuel cell 20 that receives supply of reaction gas (fuel gas and oxidizing gas) and generates electric power; an oxidizing gas supply system 30 that supplies air as the oxidizing gas to the fuel cell 20; a fuel gas supply system 40 that supplies hydrogen gas as fuel gas to the fuel cell 20; an electric power system 50 that controls charging/discharging of the electric power; and a controller 60 that controls the entire fuel cell system 10.

The fuel cell 20 is a solid-polymer electrolyte cell stack in which a plurality of cells are stacked in series. In the fuel cell 20, an oxidation reaction represented by an expression (1) described below occurs at an anode electrode, and a reduction reaction represented by an expression (2) described below occurs at a cathode electrode. In the enter fuel cell 20, an electrogenic reaction represented by an expression (3) described below occurs.

H₂→2H⁺+2e⁻ (1)

(½)O₂+2H⁺+2e⁻→H₂O (2)

H₂+(½)O₂→H₂O (3)

Each of cells constituting the fuel cell 20 includes a polymer electrolyte membrane, an anode electrode, a cathode electrode, and separators. The polymer electrolyte membrane is sandwiched between the anode electrode and the cathode electrode, that is, the anode electrode and the cathode electrode are provided on respective sides of the polymer electrolyte membrane. Thus, a sandwich structure is formed. Each of the separators is constituted by a gas-impermeable conductive member. The anode electrode and the cathode electrode are sandwiched between the separators, that is, the separators are provided on respective sides of the anode electrode and the cathode electrode. A fuel gas passage is provided between the separator and the anode electrode, and an oxidizing gas passage is provided between the separator and the cathode electrode.

Each of the anode electrode and the cathode electrode includes a catalyst layer and a gas diffusion layer. The catalyst layer includes catalyst-supporting carbon that is carbon supporting noble metal particles functioning as a catalyst, such as platinum-based noble metal particles; and a polymer electrolyte. As the platinum-based material of which the noble metal particles are made, for example, a metal catalyst (for example, Pt, Pt—Fe, Pt—Cr, Pt—Ni, or Pt—Ru) may be used. As the catalyst-supporting carbon, for example, carbon black may be used. As the polymer electrolyte, for example, a proton-conducting ion-exchange resin including a perfluorocarbon sulfonic acid polymer that is a fluorinated resin, a sulfonated poly (arylene ether sulfone) copolymer (BPSH) that is a non-fluorinated resin, or the like may be used. Each of the perfluorocarbon sulfonic acid polymer and BPSH includes a sulfonic acid group. That is, these resins have ionic properties, and thus, these resins are called “ionomers (ion+polymers)”. The gas diffusion layer is provided on the surface of the catalyst layer, and is air-permeable and electronically conductive. The gas diffusion layer is formed of carbon cloth, carbon paper, or carbon felt woven from threads made of carbon fibers.

The polymer electrolyte membrane is a proton-conducting ion-exchange membrane formed of a solid polymer material, for example, a fluorinated resin. The polymer electrolyte membrane exhibits good electric conductivity in a moist condition. The polymer electrolyte membrane, the anode electrode, and the cathode electrode constitute a membrane-electrode assembly.

As shown in FIG. 1, a voltage sensor 71 that detects the output voltage (the fuel cell voltage (FC voltage)) of the fuel cell 20, and a current sensor 72 that detects the output current (the fuel cell current (FC current)) of the fuel cell 20 are connected to the fuel cell 20.

The oxidizing gas supply system 30 includes an oxidizing gas passage 33 and an oxidation off-gas passage 34. The oxidizing gas, which is supplied to the cathode electrode of the fuel cell 20, flows through the oxidizing gas passage 33. The oxidation off-gas, which is discharged from the fuel cell 20, flows through the oxidation off-gas passage 34. In the oxidizing gas passage 33, an air compressor 32 (an oxidizing gas supply source) and a shutoff valve A1 are provided. The air compressor 32 takes in the oxidizing gas from air, and the shutoff valve A1 shuts off the supply of the oxidizing gas to the fuel cell 20. In the oxidation off-gas passage 34, a shutoff valve A2 and a back pressure adjusting valve A3 are provided. The shutoff valve A2 shuts off the discharge of the oxidation off-gas from the fuel cell 20. The back pressure adjusting valve A3 adjusts the pressure required for supplying the oxidizing gas.

The fuel gas supply system 40 includes a fuel gas supply source 41, a fuel gas passage 43, a circulation passage 44, a circulation pump 45, and a discharge passage 46. The fuel gas, which is supplied from the fuel gas supply source 41 to the anode electrode of the fuel cell 20, flows through the fuel gas passage 43. The fuel off-gas, which is discharged from the fuel cell 20, is returned to the fuel gas passage 43 through the circulation passage 44. The circulation pump 45 delivers under pressure the fuel off-gas in the circulation passage 44 to the fuel gas passage 43. The discharge passage 46 is connected to the circulation passage 44 so as to branch from the circulation passage 44.

The fuel gas supply source 41 includes, for example, a high-pressure hydrogen tank or hydrogen-storing alloy. The fuel gas supply source 41 stores hydrogen gas at a high pressure (for example, 35 MPa to 70 MPa). When a shutoff valve H1 is opened, the fuel gas flows out from the fuel gas supply source 41, and flows to the fuel gas passage 43. The pressure of the fuel gas is reduced to, for example, 200 kPa by a regulator H2 and an injector 42, and then, the fuel gas is supplied to the fuel cell 20.

A shutoff valve H4 and the discharge passage 46 are connected to the circulation passage 44. The shutoff valve H4 shuts off the discharge of the fuel off-gas from the fuel cell 20. The discharge passage 46 branches from the circulation passage 44. In the discharge passage 46, a discharge valve H5 is provided. The discharge valve H5 is operated in accordance with a command from the controller 60 so as to discharge (purge) the fuel off-gas and water (moisture) in the circulation passage 44 to the outside, the fuel off-gas containing impurities.

The fuel off-gas discharged via the discharge valve H5 is mixed with the oxidation off-gas flowing through the oxidation off-gas passage 34, and the mixed off-gas is diluted by a diluter (not shown). The circulation pump 45 is driven by a motor to circulate the fuel off-gas in a circulation system so that the fuel off-gas is circulated and supplied to the fuel cell 20.

The electric power system 50 includes a DC-DC converter 51, a battery 52, a traction inverter 53, a traction motor 54, and auxiliaries 55. The DC-DC converter 51 has the function of increasing the DC voltage supplied from the battery 52 and outputting the increased DC voltage to the traction inverter 53, and the function of decreasing the voltage of the DC power generated by the fuel cell 20 or the voltage of the regenerative power generated by the traction motor 54 through regenerative braking, and charging the battery 52 with the DC power or the regenerative power.

The battery 52 functions as, for example, a storage source that stores surplus electric power, and a storage source that stores regenerative energy during the regenerative braking. The battery 52 also functions as an energy buffer when a load varies due to acceleration or deceleration of the fuel cell vehicle. As the battery 52, a secondary battery, such as a nickel-cadmium storage battery, a nickel-hydrogen storage battery, or a lithium secondary battery, may be used. An SOC sensor 73 is connected to the battery 52. The SOC sensor 73 detects the State of charge (SOC) of the battery 52, that is, the remaining capacity of the battery 52.

The fraction inverter 53 is, for example, a Pulse-width-modulation (PWM) inverter that is operated in the pulse-width modulation. The traction inverter 53 converts the DC voltage output from the fuel cell 20 or the battery 52 to the three-phase AC voltage, in accordance with a control command from the controller 60, and thus, the traction inverter 53 controls the rotation torque of the traction motor 54. The traction motor 54 is, for example, a three-phase AC motor, and constitutes a power source of the fuel cell vehicle.

The auxiliaries 55 include motors disposed in portions in the fuel cell system 10, inverters that drive the motors, and various in-vehicle auxiliaries (for example, the air compressor 32, the injector 42, the circulation pump 45, a radiator, and a coolant circulation pump).

The controller 60 is a computer system (i.e., an Electronic Control Unit (ECU)) that includes a Central processing unit (CPU), a Read-only memory (ROM), a Random access memory (RAM), and an input-output interface. The controller 60 controls portions of the fuel cell system 10. For example, when the controller 60 receives a start signal IG output from an ignition switch, the controller 60 starts the operation of the fuel cell system 10, and determines the electric power required in the entire fuel cell system 10, based on, for example, an accelerator operation amount signal ACC output from an accelerator sensor, and a vehicle speed signal VC output from a vehicle speed sensor. The electric power required in the entire fuel cell system 10 is the sum of the vehicle traveling electric power that is the electric power required to cause the vehicle to travel, and the electric power for the auxiliaries.

The electric power for the auxiliaries includes, for example, the electric power consumed by the in-vehicle auxiliaries (for example, the air compressor 32, the circulation pump 45, and the coolant circulation pump), the electric power consumed by devices required to cause the vehicle to travel (for example, a transmission, a wheel control device, a steering device, and a suspension device), and the electric power consumed by devices disposed in a space for occupants (for example, an air-conditioning device, an illumination device, and an audio device).

The controller 60 allocates the required electric power to the fuel cell 20 and the battery 52, that is, the controller 60 determines the electric power to be output from the fuel cell 20, and the electric power to be output from the battery 52. Then, the controller 60 controls the oxidizing gas supply system 30 and the fuel gas supply system 40 such that the electric power (electric energy) generated by the fuel cell 20 coincides with the target value, and controls the DC-DC converter 51 to adjust the output voltage of the fuel cell 20, thereby controlling the operation point (the output voltage, the output current) of the fuel cell 20.

When the fuel cell system 10 is operated, in the fuel cell 20, hydrogen ions generated at the anode electrode as represented by the expression (1) passes through the electrolyte membrane, and moves to the cathode electrode, and the hydrogen ions that have reached the cathode electrode electrochemically react with oxygen in the oxidizing gas supplied to the cathode electrode as shown in the expression (2), and thus, the reaction for reducing the oxygen occurs to generate water.

The controller 60 determines whether the amount of water in the fuel cell 20 is equal to or smaller than a predetermined amount (that is, whether the fuel cell 20 is in a dried state). That is, the controller functions as a determination unit according to the invention. When the controller 60 determines that the fuel cell 20 is in the dried state as a result of performing the dryness determination, the controller 60 detects (determines) the speed of the fuel cell vehicle in which the fuel cell 20 is provided, with the use of the vehicle speed sensor. When the detected speed is equal to or higher than a predetermined threshold value, the controller 60 increases the amount of water in the fuel cell 20 to prevent dryness of the fuel cell 20. That is, the controller 60 also functions as a dryness prevention unit according to the invention. In the embodiment, as described later, an operation of increasing the operation amount of the circulation pump 45 is employed as a “dryness prevention operation”.

In the embodiment, when the controller 60 determines that the amount of water in the fuel cell 20 is equal to or smaller than the predetermined amount (that is, the fuel cell 20 is in the dried state), the controller 60 detects and determines the speed of the fuel cell vehicle with the use of the vehicle speed sensor. However, the manner in which the speed of the fuel cell vehicle is determined is not limited to the above-mentioned manner. For example, the speed of the fuel cell vehicle may be constantly detected with the use of the vehicle speed sensor, and when the controller 60 determines that the amount of water in the fuel cell 20 is equal to or smaller than the predetermined amount (that is, the fuel cell 20 is in the dried state), the controller 60 may determine the speed by reading the detected speed.

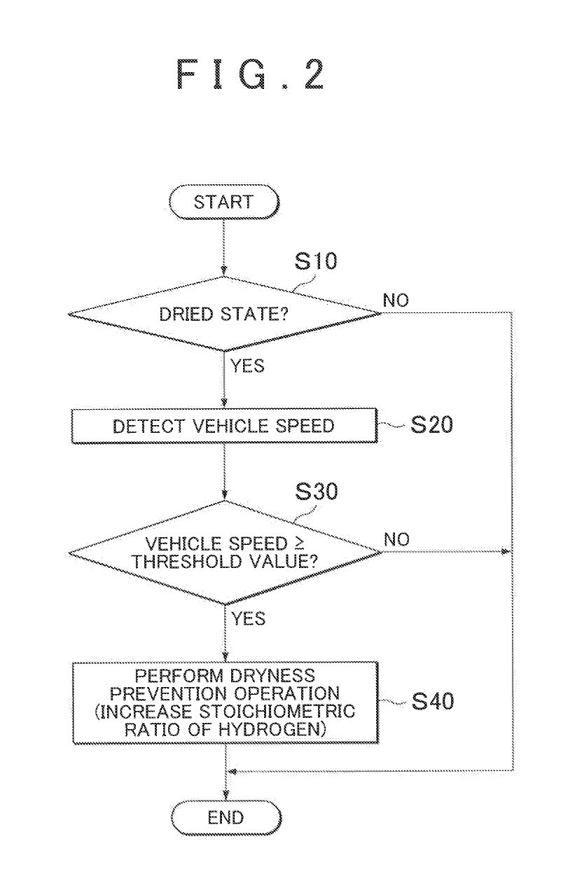

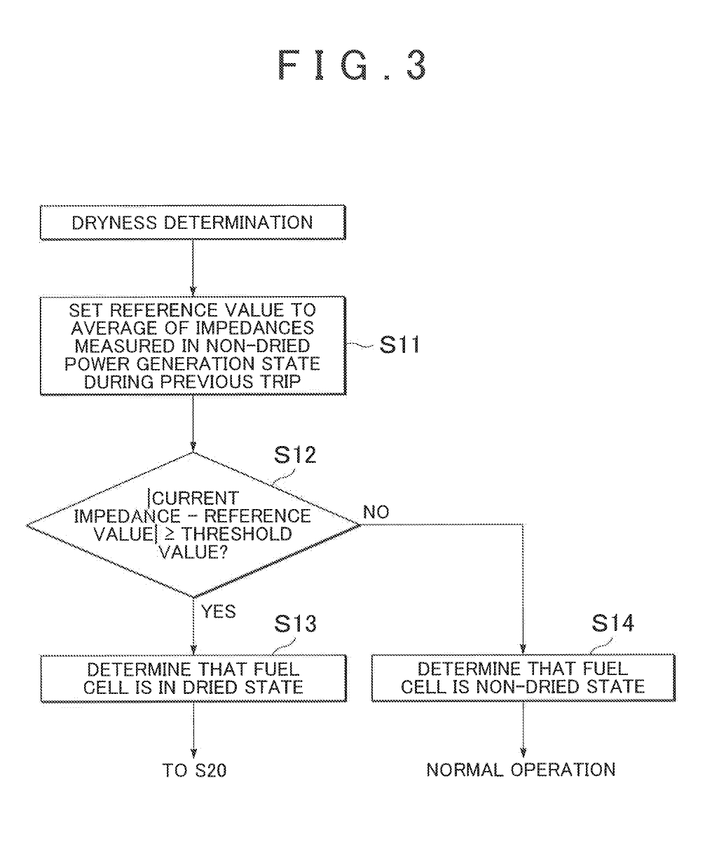

Next, an operation method for preventing dryness in the fuel cell system 10 according to the embodiment will be described with reference to flowcharts in FIG. 2 and FIG. 3.

First, as shown in FIG. 2, the controller 60 of the fuel cell system 10 determines whether the amount of water in the fuel cell 20 is equal to or smaller than the predetermined amount (that is, whether the fuel cell 20 is in the dried state) during operation (a determination process: S10). The determination process S10 will be described in detail with reference to FIG. 3.

In the determination process S10, first, a reference value is set to an average of impedances measured in a state in which the amount of water in the fuel cell 20 is larger than the predetermined amount, for example, in a predetermined non-dried power generation state (i.e., a state in which electric power is generated under predetermined conditions under which the fuel cell 20 is not dried) during a previous trip (an immediately preceding trip) (a reference value setting process: S11). In the embodiment, the power generation state (i.e., the state in which electric power is generated) at the time when (i) the current generated by the fuel cell 20 is in a predetermined range (I_{A} to I_{B}), and (ii) the temperature of the fuel cell 20 is in a predetermined range (T_{C} to T_{D}) after the fuel cell 20 is started (i.e., after the ignition switch is turned on) is regarded as the “non-dried power generation state”. That is, the power generation state at the time when the conditions (i) and (ii) are satisfied after the fuel cell 20 is started is regarded as the “non-dried power generation state”. In the reference value setting process S11, the controller 60 records a reference value (Z_{base}) that is set to the average of a plurality of impedances measured in the non-dried power generation state in a predetermined time period (t_{d}) during the previous trip of the fuel cell vehicle.

In the embodiment, the reference value is set to the average of the impedances measured during the “previous (immediately preceding)” trip. However, the reference value may be set to the average of the impedances measured in “a plurality of previous trips (for example, five previous trips)”, or may be set to the average of the impedances measured in a predetermined time period (for example, five minutes) in an early part of the “current” trip in the case where the current trip is relatively long.

Subsequently to the reference value setting process S11, the controller 60 determines whether a difference (ΔZ) between the set reference value (Z_{base}) and a currently measured impedance (Z_{now}) is equal to or larger than a predetermined threshold value (ΔZₜₕ) (an impedance determination process: S12). When the difference (ΔZ) is smaller than the predetermined threshold value (ΔZₜₕ), the controller 60 determines that fuel cell 20 is in the non-dried state, and continues the operation that has been performed (a non-dryness output process: S14). In contrast, when the controller 60 determines that the difference (ΔZ) is equal to or larger than the predetermined threshold value (ΔZₜₕ), the controller 60 determines that the amount of water in the fuel cell 20 is equal to or smaller than the predetermined amount (i.e., the fuel cell 20 is in the dried state) (a dryness output process: S13).

When the controller 60 determines that the amount of water in the fuel cell 20 is equal to or smaller than the predetermined amount (i.e., the fuel cell 20 is in the dried state), the controller 60 detects (determines) the speed of the fuel cell vehicle in which the fuel cell 20 is provided, with the use of the vehicle speed sensor (a speed detecting process: S20), as shown in FIG. 2. Then, the controller 60 determines whether the speed detected in the speed detecting process S20 is equal to or higher than the predetermined threshold value (a speed determination process S30). When the controller 60 determines that the detected speed is lower than the predetermined threshold value, the controller 60 does not perform the dryness prevention operation, and continues the operation that has been performed. In contrast, when the controller 60 determines that the speed detected in the speed detecting process S20 is equal to or higher than the predetermined threshold value, the controller 60 performs the dryness prevention operation for preventing (eliminating) the dryness of the fuel cell 20 (a dryness prevention process: S40).

More specifically, when the speed detected with the use of the vehicle speed sensor is equal to or higher than the predetermined threshold value, the controller 60 increases the amount of water contained in the fuel gas supplied to the fuel cell 20 by making the operation amount of the circulation pump 45 larger than a normal operation amount (the operation amount of the circulation pump 45 at normal times) so as to increase the amount of the fuel off-gas delivered under pressure to the fuel gas passage 43, in the dryness prevention process S40.

The “normal” operation amount of the circulation pump 45 (i.e., the operation amount of the circulation pump 45 at “normal times”) signifies the operation amount of the circulation pump 45 for ensuring the stoichiometric ratio of hydrogen (for example, approximately 1.2 to 2.0) required to perform the normal power generation. When the controller 60 determines that the speed detected with the use of the vehicle speed sensor is equal to or higher than the predetermined threshold value, the controller 60 increases the operation amount of the circulation pump 45 such that the value of the stoichiometric ratio of hydrogen becomes a value (for example, approximately 2.5 to 4.0) higher than the stoichiometric ratio of hydrogen at normal times. At this time, the value of the stoichiometric ratio of hydrogen may be changed according to the difference (ΔZ) between the reference value (Z_{base}) of the impedance and the currently measured impedance (Z_{now}). For example, when the difference (ΔZ) is relatively large, the stoichiometric ratio of hydrogen may be set to a relatively large value (for example, approximately 4.0), and when the difference (ΔZ) is relatively small, the stoichiometric ratio of hydrogen may be set to a relatively small value (for example, approximately 2.5). By changing the stoichiometric ratio of hydrogen in the above-mentioned manner, the dryness prevention operation can be appropriately performed according to the degree of dryness.

Then, when a predetermined end condition is satisfied, the controller 60 ends the dryness prevention operation. As the end condition, for example, (1) a condition that the difference (ΔZ) between the reference value (Z_{base}) and the currently measured impedance (Z_{now}) becomes smaller than the predetermined threshold value (ΔZₜₕ), or (2) a condition that the speed of the fuel cell vehicle is lower than the predetermined threshold value may be employed.

In the fuel cell system 10 according to the embodiment described above, the dryness prevention operation can be performed only when (i) the fuel cell 20 is in the dried state and (ii) the speed of the fuel cell vehicle is equal to or higher than the predetermined threshold value (i.e., only when both of the conditions (i) and (ii) are satisfied). Accordingly, the operating noise of the device (the circulation pump 45) used to perform the dryness prevention operation can be drowned out by the sound or noise caused due to the traveling of the fuel cell vehicle (for example, noise of tires or sound of wind). Thus, it is possible to perform the dryness prevention operation without making an occupant of the fuel cell vehicle feel uncomfortable.

In the fuel cell system 10 according to the embodiment described above, the reference value is set to the average of the impedances measured in the state in which the amount of water in the fuel cell 20 is larger than the predetermined amount (i.e., in the predetermined non-dried power generation state during the previous trip (the immediately preceding trip)), and the dryness determination can be performed by comparing the reference value and the currently measured impedance. That is, the immediately preceding value of the impedance in the non-dried power generation state is employed as the reference value, and the dryness determination can be performed using the reference value. Therefore, even when the reference value is changed due to aged deterioration of the fuel cell 20, it is possible to accurately perform the dryness determination.

In the fuel cell system 10 according to the embodiment described above, when the fuel cell 20 is in the dried state and the speed of the fuel cell vehicle is equal to or higher than the predetermined threshold value, the amount of water contained in the fuel gas supplied to the fuel cell 20 can be increased by making the operation amount of the circulation pump 45 larger than the normal operation amount so as to increase the amount of the fuel off-gas delivered under pressure to the fuel gas passage 43. Since the electric power consumed by the circulation pump 45 is much smaller than the electric power consumed by the air compressor 32, it is possible to prevent the dryness of the fuel cell 20 while saving the fuel. Further, as described above, when the operation amount of the circulation pump 45 is increased, the operating noise of the circulation pump 45 can be drowned out by the sound or noise caused due to the movement of the fuel cell vehicle.

### Second Embodiment

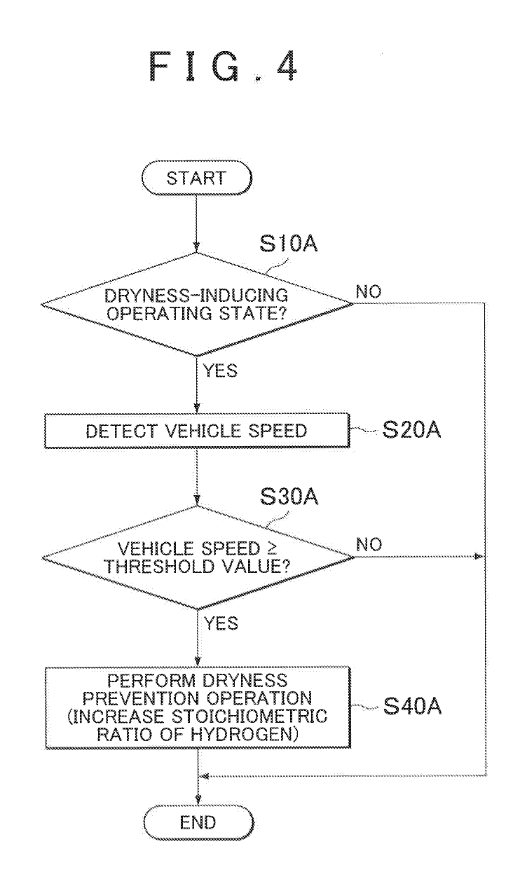

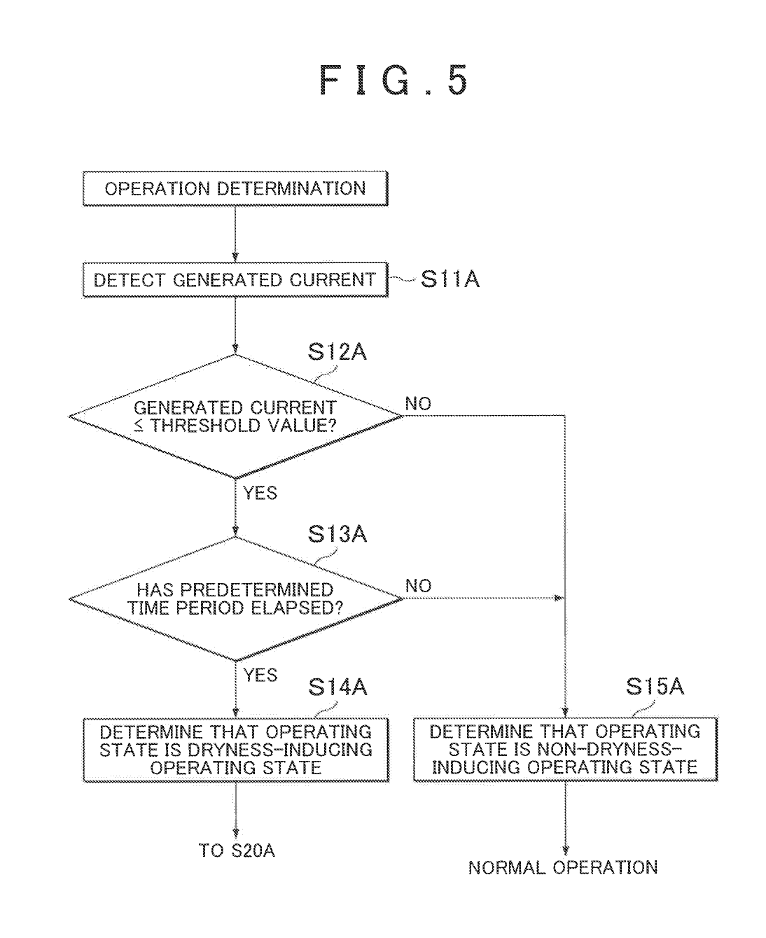

Next, a second embodiment of the invention will be described with reference to FIG. 4 and FIG. 5. In a fuel cell system according to the second embodiment, the function (control program) of a controller is different from that of the controller 60 of the fuel cell system 10 according to the first embodiment. The configuration of the other portions of the fuel cell system according to the second embodiment is substantially the same as the configuration of the corresponding portions of the fuel cell system according to the first embodiment, and therefore, the illustration of the system configuration according to the second embodiment is omitted. Further, in the second embodiment, the same portions as those in the first embodiment are denoted by the same reference numerals as those in the first embodiment, and the detailed descriptions thereof are omitted.

The controller of the fuel cell system according to the second embodiment (hereinafter, the controller in the second embodiment will be denoted by the reference numeral “60A” in order to distinguish it from the controller 60 in the first embodiment) is a computer system (an Electronic Control Unit (ECU)) including a CPU, a ROM, a RAM, and an input-output interface, and the controller 60A controls portions of the fuel cell system as in the first embodiment.

The controller 60A in the embodiment determines whether the operating state of the fuel cell 20 is an operating state (a dryness-inducing operating state) in which the amount of water in the fuel cell 20 is decreased and the dryness of the fuel cell 20 is to be induced. That is, the controller 60A functions as an operation determination unit according to the invention. When the controller 60A determines that the fuel cell 20 is in the dryness-inducing operating state as a result of performing the operation determination, the controller 60A detects (determines) the speed of the fuel cell vehicle in which the fuel cell 20 is provided, with the use of the vehicle speed sensor. When the detected speed is equal to or higher than a predetermined threshold value (i.e., when the controller 60A determines that the detected speed is equal to or higher than a predetermined threshold value), the controller 60A performs the dryness prevention operation for preventing the dryness of the fuel cell 20, by increasing the amount of water in the fuel cell 20. That is, the controller 60A also functions as the dryness prevention unit according to the invention. In the embodiment, the operation of increasing the operation amount of the circulation pump 45 is employed as the “dryness prevention operation”, as in the first embodiment.

Next, the operation method for preventing the dryness of the fuel cell system according to the embodiment will be described with reference to flowcharts in FIG. 4 and FIG. 5.

As shown in FIG. 4, first, the controller 60A of the fuel cell system determines whether the operating state of the fuel cell 20 is the dryness-inducing operating state in which the dryness of the fuel cell 20 is to be induced (an operation determination process: S10A). The operation determination process S10A will be described in detail with reference to FIG. 5.

In the operation determination process S10A, first, the controller 60A detects the current generated by the fuel cell 20 with the use of the current sensor 72 (a current detecting process: S11A), and determines whether the detected current is equal to or smaller than a predetermined threshold value (for example, 75 A) (a current determination process: S12A). When the controller 60A determines that the current detected with the use of the current sensor 72 is larger than the predetermined threshold value, the controller 60A determines that the fuel cell 20 is in a non-dryness-inducing operating state (i.e., in a state in which dryness is not to be induced), and continues the operation that has been performed (a non-dryness output process: S15A). In contrast, when the controller 60A determines that the detected current is equal to or smaller than the predetermined threshold value in the current determination process S12A, the controller 60A determines whether the current continues to flow for a predetermined time period (for example, 1 minute) or longer (a continuation determination process: S13A).

When the controller 60A determines that the continuation time period, during which the generated current equal to or smaller than the predetermined threshold value continues to flow, is shorter than the predetermined time period in the continuation determination process S13A, the controller 60A determines that the fuel cell 20 is in the non-dryness-inducing operating state, and continues the operation that has been performed (the non-dryness output process: S15A). In contrast, when the controller 60A determines that the generated current equal to or smaller than the predetermined threshold value continues to flow for the predetermined time period or longer in the continuation determination process S13A, the controller 60A determines that the operating state of the fuel cell 20 is the dryness-inducing operating state (a dryness output process: S14A).

When the controller 60A determines that the operating state of the fuel cell 20 is the dryness-inducing operating state as described above, the controller 60A detects (determines) the speed of the fuel cell vehicle in which the fuel cell 20 is provided, with the use of the vehicle speed sensor, as shown in FIG. 4 (a speed detecting process: S20A). Then, the controller 60A determines whether the speed detected in the speed detecting process S20A is equal to or higher than a predetermined threshold value (a speed determination process: S30A). When the controller 60A determines that the detected speed is lower than the predetermined threshold value, the controller 60A continues the operation that has been performed, without performing the dryness prevention operation. In contrast, when the controller 60A determines that the speed detected in the speed detecting process S20A is equal to or higher than the predetermined threshold value, the controller 60A performs the dryness prevention operation for preventing the dryness of the fuel cell 20 (a dryness prevention process: S40A).

More specifically, when the speed detected with the use of the vehicle speed sensor is equal to or higher than the predetermined threshold value, the controller 60A increases the amount of water contained in the fuel gas supplied to the fuel cell 20, by making the operation amount of the circulation pump 45 larger than the normal operation amount so as to increase the amount of the fuel off-gas delivered under pressure to the fuel gas passage 43 as in the first embodiment, in the dryness prevention process S40A.

The operation amount of the circulation pump 45 at “normal times” signifies the operation amount of the circulation pump 45 for ensuring the stoichiometric ratio of hydrogen (for example, approximately 1.2 to 2.0) required to perform the normal power generation. When the controller 60A determines that the speed detected with the use of the vehicle speed sensor is equal to or higher than the predetermined threshold value, the controller 60A increases the operation amount of the circulation pump 45 such that the value of the stoichiometric ratio of hydrogen becomes a value (for example, approximately 2.5 to 4.0) higher than the stoichiometric ratio of hydrogen at normal times. At this time, the value of the stoichiometric ratio of hydrogen may be changed according to the value of the current generated by the fuel cell 20. For example, when the current detected with the use of the current sensor 72 is relatively small (for example, 25 A), the value of the stoichiometric ratio of hydrogen may be set to a relatively large value (for example, approximately 4.0), and when the current detected with the use of the current sensor 72 is relatively large (for example, 50 A), the value of the stoichiometric ratio of hydrogen may be set to a relatively small value (for example, approximately 2.5). By changing the stoichiometric ratio of hydrogen in the above-mentioned manner, the dryness prevention operation can be appropriately performed according to the degree of dryness.

Then, when a predetermined end condition is satisfied, the controller 60A ends the dryness prevention operation. As the end condition, for example, (1) a condition that the current detected with the use of the current sensor 72 is larger than the predetermined threshold value, (2) a condition that the current detected with the use of the current sensor 72 is equal to or smaller than the predetermined threshold value, but the continuation time period, during which the current continues to flow, is shorter than the predetermined time period, or (3) a condition that the speed of the fuel cell vehicle is lower than the predetermined threshold value may be employed.

In the fuel cell system according to the embodiment described above, the dryness prevention operation can be performed only when (i) the operating state of the fuel cell 20 is the dryness-inducing operating state and (ii) the speed of the fuel cell vehicle is equal to or higher than the predetermined threshold value (i.e., only when both of the conditions (i) and (ii) are satisfied). Accordingly, the operating noise of the device (the circulation pump 45) used to perform the dryness prevention operation can be drowned out by the sound or noise caused due to the traveling of the fuel cell vehicle (for example, noise of tires or sound of wind). Thus, it is possible to perform the dryness prevention operation without making an occupant of the fuel cell vehicle feel uncomfortable. Further, instead of directly determining whether the fuel cell 20 is in the dried state, the operating state of the fuel cell 20 is determined, and when the operating state is the dryness-inducing operating state, the dryness preventing operation is performed. Therefore, it is possible to prevent the dryness of the fuel cell 20 from occurring in advance.

In the fuel cell system according to the embodiment described above, when (i) the current generated by the fuel cell 20 is in a low load range (that is, the current generated by the fuel cell 20 is equal to or smaller than the predetermined threshold value), and (ii) the current continues to flow for the predetermined time period or longer (i.e., when both of the conditions (i) and (ii) are satisfied), it is possible to determine that the operating state of the fuel cell 20 is the dryness-inducing operating state. That is, it is possible to determine the probability (possibility) of occurrence of dryness based on the current generated by the fuel cell 20, instead of directly determining whether the fuel cell 20 is in the dried state based on, for example, the measured impedance. Accordingly, even in the low load range where the change in the impedance is small, it is possible to prevent the dryness from occurring in advance.

In the fuel cell system according to the embodiment described above, when (i) the operating state of the fuel cell 20 is the dryness-inducing operating state, and (ii) the speed of the fuel cell vehicle is equal to or higher than the predetermined threshold value (i.e., when both of the conditions (i) and (ii) are satisfied), the amount of water contained in the fuel gas supplied to the fuel cell 20 can be increased by making the operation amount of the circulation pump 45 larger than the normal operation amount so as to increase the amount of the fuel off-gas delivered under pressure to the fuel gas passage 43. Since the electric power consumed by the circulation pump 45 is much smaller than the electric power consumed by the air compressor 32, it is possible to prevent the dryness of the fuel cell 20 while saving the fuel. Further, as described above, when the operation amount of the circulation pump 45 is increased, the operating noise of the circulation pump 45 can be drowned out by the sound or noise caused due to the movement of the fuel cell vehicle.

In the second embodiment, when (i) the current generated by the fuel cell 20 is equal to or smaller than the predetermined threshold value, and (ii) the generated current continues for the predetermined time period or longer (i.e., when the conditions (i) and (ii) are satisfied), it is determined that the operating state of the fuel cell 20 is the dryness-inducing operating state. However, the method of performing the operation determination is not limited to the above-mentioned method.

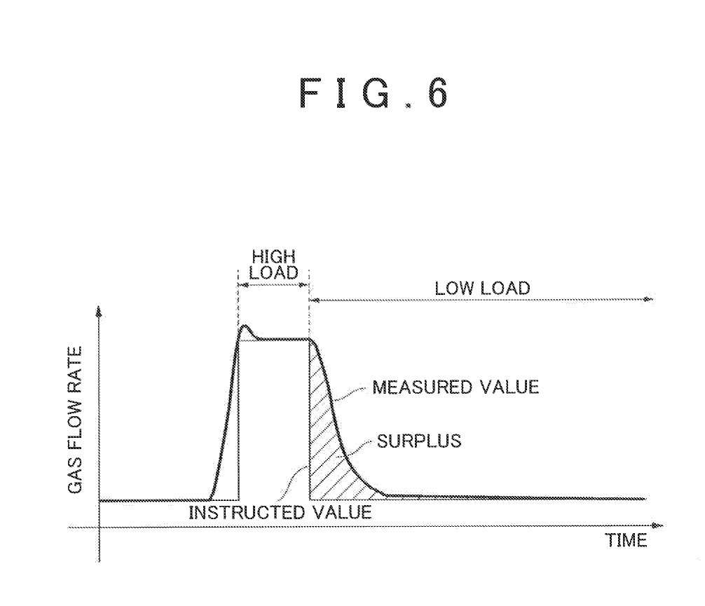

For example, when the load of the fuel cell 20 (required electric power) sharply decreases from a high load to a low load, the response of the reaction gas actually supplied to the fuel cell 20 (a measured value) lags behind an instructed value as shown in FIG. 6. Therefore, when the load is high, a large amount of the reaction gas (particularly, air as the oxidizing gas) is supplied to the fuel cell 20, and when the load becomes low, there is a surplus of the reaction gas. Thus, it is estimated that the fuel cell 20 is to be brought to the dried state due to the surplus reaction gas. Therefore, a rate of decrease in the load of the fuel cell 20 (a decrease amount of the load per unit time) is calculated, and when the calculated rate of decrease in the load is larger than a predetermined threshold value (for example, in a case where a change of 100 A or smaller per one second in the generated current is permitted, the predetermined threshold value is 100 (=100/1)(A/s)), it can be determined that the operating state of the fuel cell 20 is the dryness-inducing operating state. Instead of calculating the rate of decrease in the load of the fuel cell 20, “a rate of decrease in the output of the fuel cell 20 (for example, a decrease amount of the generated current per unit time)” may be calculated, and the calculated rate of decrease in the output is larger than a predetermined threshold value, it may be determined that the operating state of the fuel cell 20 is the dryness-inducing operating state.

When the temperature of the fuel cell 20 is equal to or higher than a predetermined threshold value (for example 60° C. to 70° C.), it may be determined that the operating state of the fuel cell 20 is the dryness-inducing operating state. Further, a winter mode operation, for example, an operation of increasing the temperature of the fuel cell 20 may be performed in order to prevent freezing. When the winter mode operation continues to be performed for a predetermined time period or longer, it may be determined that the operating state of the fuel cell 20 is the dryness-inducing operating state.

In each of the above-mentioned embodiments, the operation of increasing the operation amount of the circulation pump 45 is employed as the “dryness prevention operation”. However, the example of the “dryness prevention operation” is not limited to the above-mentioned operation.

For example, the controller 60 (60A) may decrease the supply amount of the oxidizing gas so as to decrease the amount of water carried to the outside of the fuel cell 20, by controlling the back pressure adjusting valve A3 so as to make the pressure required for supplying the oxidizing gas larger than that at normal times. That is, the operation of increasing the pressure required for supplying the oxidizing gas may be employed as the “dryness prevention operation”.

The controller 60 (60A) may decrease the amount of water carried to the outside of the fuel cell 20, by controlling the air compressor 32 so as to make the amount of the oxidizing gas supplied from the air compressor 32 smaller than a normal amount (i.e., the amount of the oxidizing gas supplied from the air compressor 32 at normal times). That is, the operation of decreasing the amount of the oxidizing gas supplied from the air compressor 32 may be employed as the “dryness prevention operation”. The amount of the oxidizing gas supplied from the air compressor 32 at “normal times” signifies, for example, the amount of the oxidizing gas that makes the stoichiometric ratio of air equal to approximately 1.45 to 1.6. The controller 60 (60A) may decrease the amount of the oxidizing gas supplied from the air compressor 32 such that the stoichiometric ratio of air becomes a value (for example, approximately 1.3 to 1.4) that is smaller than the stoichiometric ratio of air at normal times.

Further, the controller 60 (60A) may suppress a decrease in the amount of water in the fuel cell 20 by controlling the operating state of the fuel cell 20 so as to decrease the operating temperature of the fuel cell 20 by a few degrees. That is, the operation of decreasing the operating temperature of the fuel cell 20 may be employed as the “dryness prevention operation”.

As the “dryness prevention operation”, at least two operations among the operation of increasing the operation amount of the circulation pump 45, the operation of increasing the pressure required for supplying the oxidizing gas by controlling the back pressure adjusting valve A3, the operation of decreasing the amount of the oxidizing gas supplied from the air compressor 32, and the operation of decreasing the operating temperature of the fuel cell 20 may be appropriately combined.

In each of the above-mentioned embodiments, as the moving body, the “fuel cell vehicle” is employed. However, the fuel cell system according to the invention may be provided in various moving bodies (for example, a robot, a vessel, or an aircraft) other than the fuel cell vehicle.

The invention is not limited to the above-mentioned embodiments. Embodiments obtained by appropriately adding design modifications to the above-mentioned embodiments are included in the scope of the invention, as long as the embodiments have the features of the invention. That is, the elements, arrangement of the elements, the materials of the elements, the conditions relating to the elements, the shapes of the elements, the sizes of the elements, and the like in each of the above-mentioned embodiments are not limited to those exemplified in the embodiment, and may be appropriately changed. Further, the elements in the above-mentioned embodiments may be combined with each other, as long as the combinations are technically possible. The combinations of the elements are included in the scope of the invention, as long as the combinations include the features of the invention.

What is claimed is:

1. A fuel cell system comprising:
a fuel cell provided in a vehicle; and
an electronic control unit configured to determine whether an amount of water in the fuel cell is equal to or smaller than a predetermined amount, and to prevent dryness of the fuel cell by increasing the amount of water in the fuel cell when a speed of the vehicle is equal to or higher than a predetermined threshold value in a case where the electronic control unit determines that the amount of water in the fuel cell is equal to or smaller than the predetermined amount.

2. The fuel cell system according to claim 1, wherein the electronic control unit is configured to set a reference value to an average of impedances measured in a state in which the amount of water in the fuel cell is larger than the predetermined amount, and to determine that the amount of water in the fuel cell is equal to or smaller than the predetermined amount when a difference between the reference value and a currently measured impedance is equal to or larger than a predetermined threshold value.

3. The fuel cell system according to claim 1, further comprising:
a fuel gas passage through which fuel gas is supplied to the fuel cell;
a circulation passage through which fuel off-gas discharged from the fuel cell is returned to the fuel gas passage; and
a circulation pump that delivers under pressure the fuel off-gas in the circulation passage, to the fuel gas passage, wherein the electronic control unit is configured to make an operation amount of the circulation pump larger than a normal operation amount when the speed of the vehicle is equal to or higher than the predetermined threshold value in the case where the electronic control unit determines that the amount of water in the fuel cell is equal to or smaller than the predetermined amount.

4. A fuel cell system comprising:
a fuel cell provided in a vehicle; and
an electronic control unit configured to determine whether an operating state of the fuel cell is a dryness-inducing operating state in which an amount of water in the fuel cell is decreased and dryness of the fuel cell is to be induced, and to perform a dryness prevention operation for preventing the dryness of the fuel cell by increasing the amount of water in the fuel cell when a speed of the vehicle is equal to or higher than a predetermined threshold value in a case where the electronic control unit determines that the operating state of the fuel cell is the dryness-inducing operating state.

5. The fuel cell system according to claim 4, wherein the electronic control unit is configured to determine that the operating state of the fuel cell is the dryness-inducing operating state when a current generated by the fuel cell is equal to or smaller than a predetermined threshold value and the generated current continues to flow for a predetermined time period or longer.

6. The fuel cell system according to claim 4, wherein the electronic control unit is configured to determine that the operating state of the fuel cell is the dryness-inducing operating state when a rate of decrease in a load of the fuel cell is larger than a predetermined threshold value.

7. The fuel cell system according to claim 4, wherein the electronic control unit is configured to determine that the operating state of the fuel cell is the dryness-inducing operating state when a rate of decrease in an output of the fuel cell is larger than a predetermined threshold value.

8. The fuel cell system according to claim 4, wherein the electronic control unit is configured to determine that the operating state of the fuel cell is the dryness-inducing operating state when a temperature of the fuel cell is equal to or higher than a predetermined threshold value.

9. The fuel cell system according to claim 4, further comprising:
a fuel gas passage through which fuel gas is supplied to the fuel cell;
a circulation passage through which fuel off-gas discharged from the fuel cell is returned to the fuel gas passage; and
a circulation pump that delivers under pressure the fuel off-gas in the circulation passage, to the fuel gas passage, wherein the electronic control unit is configured to make an operation amount of the circulation pump larger than a normal operation amount when the speed of the vehicle is equal to or higher than the predetermined threshold value in the case where the electronic control unit determines that the operating state of the fuel cell is the dryness-inducing operating state.
